(19) United States
(12) Patent Application Publication
(10) Pub. No.: US 2014/0329119 A1
(43) Pub. Date: Nov. 6, 2014

(54) RUBBER BOOT FOR BATTERY PACK

(71) Applicant: BLACK & DECKER INC., Newark, DE (US)

(72) Inventors: James C. TIRONE, Baltimore, MD (US); Jason BUSSCHAERT, Bel Air, MD (US)

(73) Assignee: BLACK & DECKER INC., Newark, DE (US)

(21) Appl. No.: 14/267,113

(22) Filed: May 1, 2014

Related U.S. Application Data
(60) Provisional application No. 61/818,566, filed on May 2, 2013.

(51) Int. Cl. H01M 2/10

(52) U.S. Cl. CPC H01M 2/1022; H01M 2220/30
USPC 429/90; 429/96

(57) ABSTRACT

A battery pack and a protective cover for the battery pack. The battery pack is operatively connectable to a power tool in order to provide electrical power to the power tool, the battery pack comprising a base portion and an upper portion. A protective boot is removably coupled to the battery pack and comprises an elastic material and forming a substantially rectangular box shape conforming to the base portion of the battery pack such that when it is coupled to the battery pack it is form fitting and covers at least a portion of an outer surface of the base portion. At least one terminal slot and the plurality of guide rails of the battery pack are exposed when the protective boot is coupled to the battery pack.

### CROSS-REFERENCE TO RELATED APPLICATIONS

This application claims the benefit of U.S. Provisional Application No. 61/818,566, filed May 2, 2013, the entire disclosure of this is incorporated herein by reference.

### BACKGROUND OF THE INVENTION

The present disclosure relates to a technique for protecting a battery pack for a power tool.

### SUMMARY OF THE INVENTION

According to one aspect of the invention, there is a battery pack and a protective cover for the battery pack. The battery pack is operatively connectable to a power tool in order to provide electrical power to the power tool, the battery pack comprising a base portion and an upper portion, the base portion having a generally rectangular box shape and the upper portion extending from the base portion, the upper portion including at least one terminal slot and a plurality of guide rails. The protective boot is removably coupled to the battery pack and comprises an elastic material and forming a substantially rectangular box shape conforming to the base portion of the battery pack such that when it is coupled to the battery pack it is form fitting and covers at least a portion of an outer surface of the base portion. At least one terminal slot and the plurality of guide rails of the battery pack are exposed when the protective boot is coupled to the battery pack.

The base portion of the battery pack may further include at least one of projections and recesses and the protective boot comprises at least one of cavities for receiving the projections and projections for engaging the recesses.

The battery pack may further include a plurality of projections extending from the base portion and the protective boot comprises a plurality of cavities which receive the plurality of recesses.

The plurality of projections may include at least a first projection of a first shape and a second projection of a second shape and the plurality of cavities comprise at least a first cavity with a first cavity shape and a second cavity with a second cavity shape.

The base portion may include graphical information and the protective boot comprises at least one window through which the graphical information is visible.

The at least one window may include a hole in the protective boot.

The graphical information may include alphanumeric characters.

The projections may include screw boss projections.

The projections may include a portion which is at least substantially cylindrical.

The cavities may include a portion which is at least substantially cylindrical to receive the at least substantially cylindrical projections.

The upper portion of the battery pack may be exposed when the protective boot is coupled to the battery pack.

According to another aspect of the invention there is a power tool assembly including a battery pack, a protective boot for the battery pack and a power tool. The battery pack is operatively connectable to the power tool in order to provide electrical power to the power tool, the battery pack including a base portion and an upper portion, the base portion having a generally rectangular box shape and the upper portion extending from the base portion and the upper portion including at least one terminal slot and a plurality of guide rails. The protective boot is removably coupled to the battery pack and including an elastic material and forming a substantially rectangular box shape conforming to the base portion of the battery pack and covering at least a portion of an outer surface of the base portion. The base portion of the battery pack further includes at least one of projections and recesses and the protective boot includes at least one of cavities for receiving the projections and projections for engaging the recesses.

The projections include at least a first projection of a first shape and a second projection of a second shape and the plurality of cavities comprise at least a first cavity with a first cavity shape and a second cavity with a second cavity shape.

The base portion may include graphical information and the protective boot may include at least one window through which the graphical information is visible.

The at least one window may be a hole in the protective boot.

The graphical information may include alphanumeric characters.

The projections may include a portion which is at least substantially cylindrical.

The cavities may include a portion which is at least substantially cylindrical to receive the at least substantially cylindrical projections.

According to another aspect, there is a protective cover for a battery pack including a boot comprising an elastic material and forming a substantially rectangular box shape opening in which at least a portion of the battery pack can be received. The boot includes a plurality of recesses for receiving a plurality of projections from the battery pack. The plurality of recesses include a first recess having a first shape and a second recess having a second shape different than the first shape.

The protective boot may include at least one window, the window being located on a side surface.

### BRIEF DESCRIPTION OF THE DRAWINGS

FIG. 1 is a perspective front view of an example embodiment of a protective boot fit on a battery pack;

FIG. 2 is a perspective rear view of the example embodiment of the protective boot fit on the battery pack;

FIG. 3 is a perspective view of the example embodiment of the protective boot;

FIG. 4 is a front view of the example embodiment of the protective boot;

FIG. 5 is a rear view of the example embodiment of the protective boot;

FIG. 6 is a top view of the example embodiment of the protective boot;

FIG. 7 is a bottom view of the example embodiment of the protective boot;

FIG. 8 is a front perspective view of the example embodiment of a battery pack;

FIG. 9 is a bottom rear perspective view of the example embodiment of the battery pack;

FIG. 10 is an upper rear perspective view of the example embodiment of the battery pack;

FIG. 11 is a perspective view of a drill with the example embodiment of a protective boot fit on a battery pack;

FIG. 12 is another perspective view of the drill with the example embodiment of a protective boot fit on a battery pack; and

FIG. 13 is a perspective rear view of the example embodiment of the protective boot fit on the battery pack.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION OF EXEMPLARY EMBODIMENTS OF THE INVENTION

Example embodiments will now be described more fully with reference to the accompanying drawings.

Battery packs, such as those for use with a power tool, may be damaged when the battery pack impacts a hard object such as a floor, wall or steps. This can happen, for example, when a battery or a tool with a battery is dropped by a user. Accordingly, it may be advantageous to provide a protective boot made of synthetic rubber or another elastic material which can be fit around the boot. It may be advantageous for the protective boot to be removable and easily attached and removed from the battery pack so that old or worn protective boots may be replaced. Additionally, it may be advantageous for the protective boot to conform to the shape of the battery pack it is covering so that it is form fit to the battery pack and is not inadvertently removed.

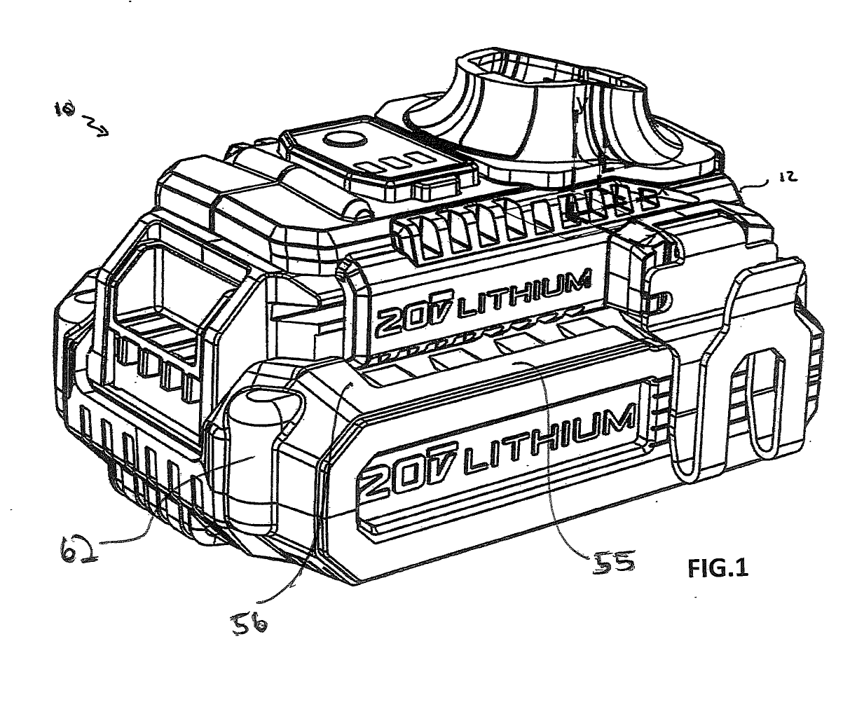

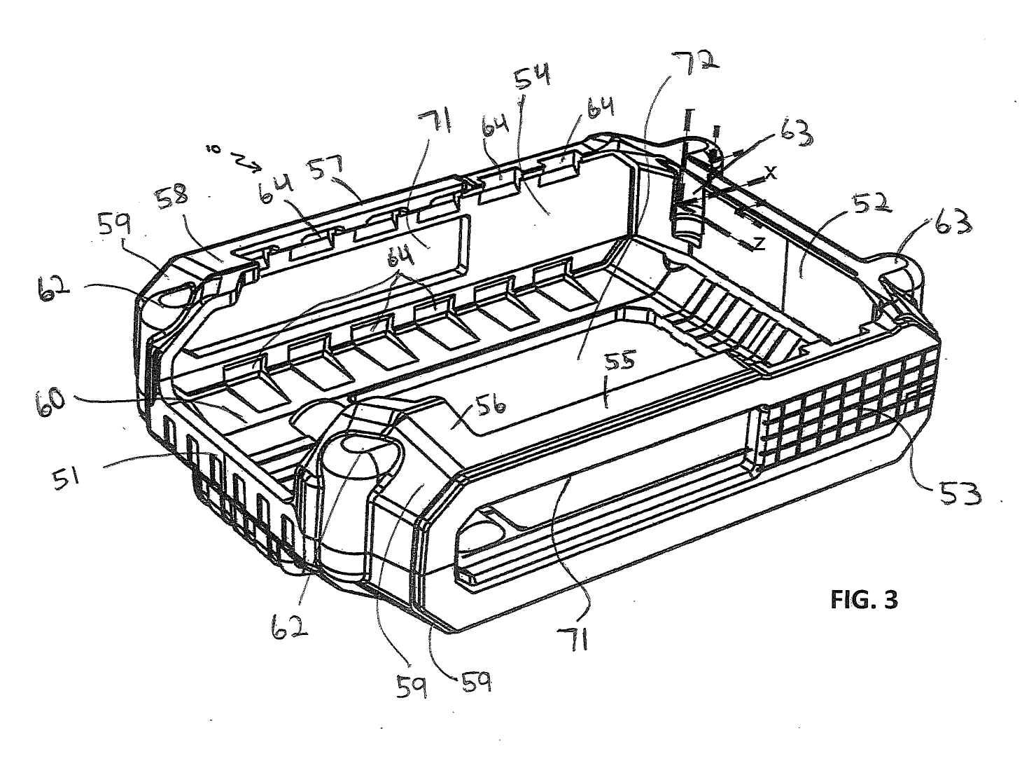

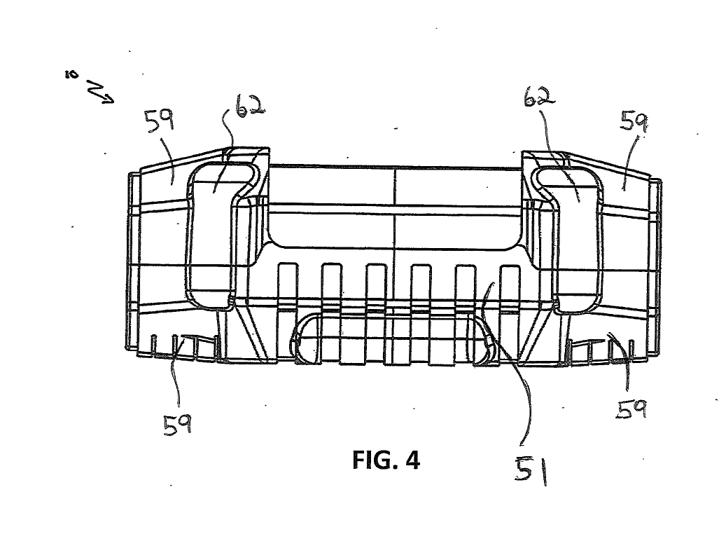

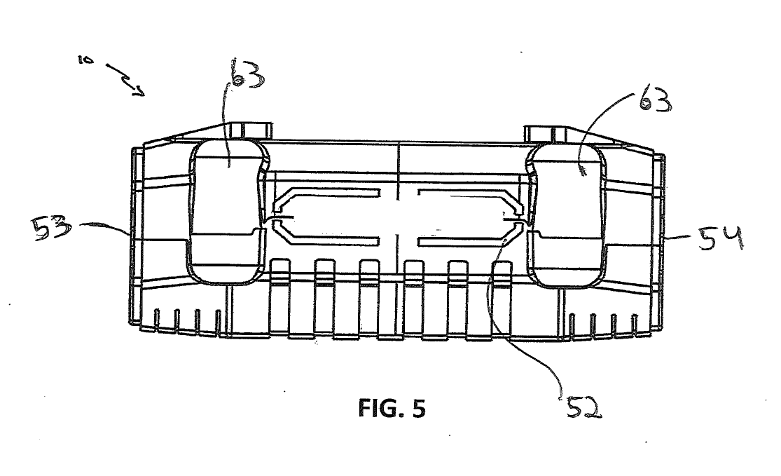

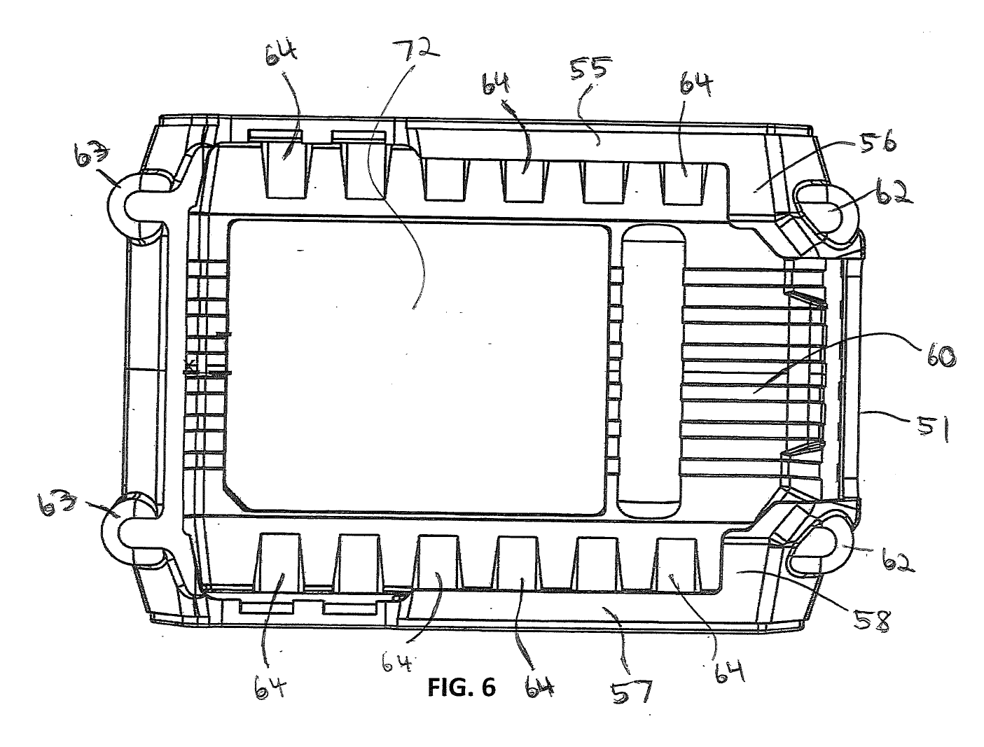

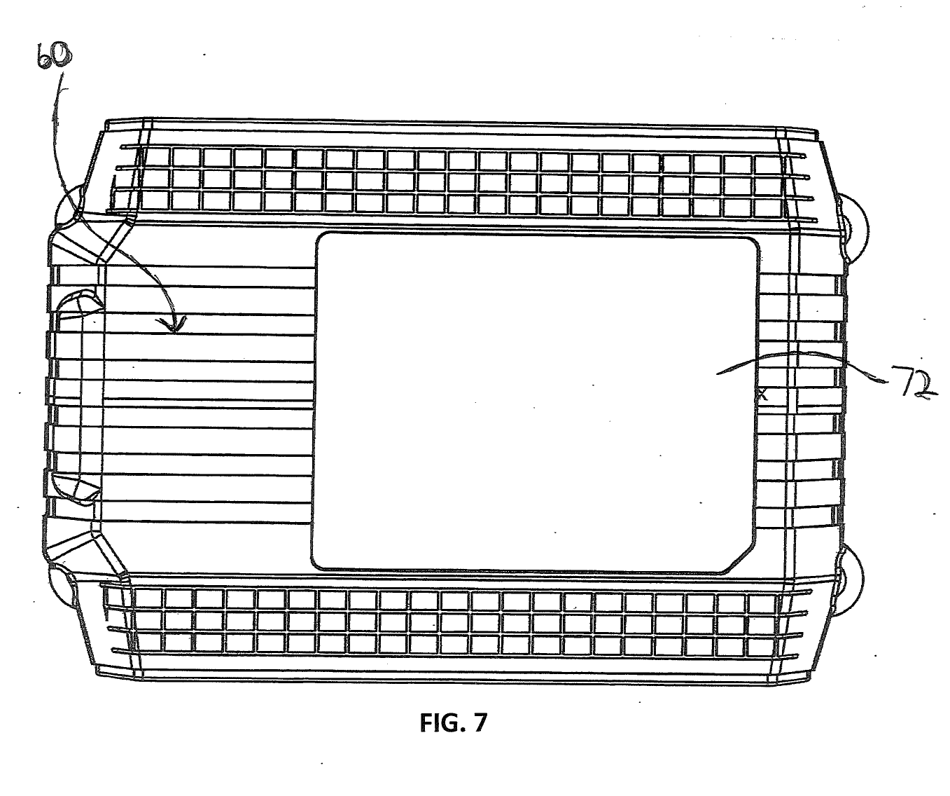

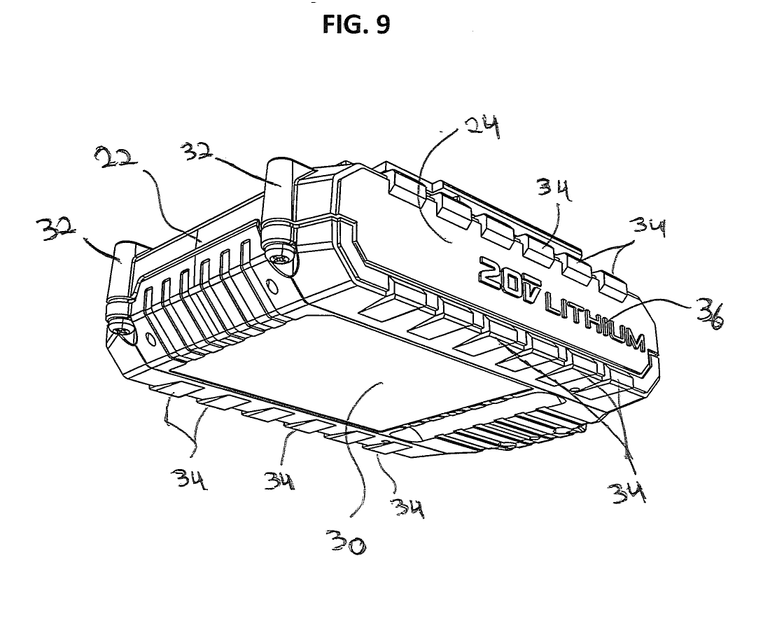

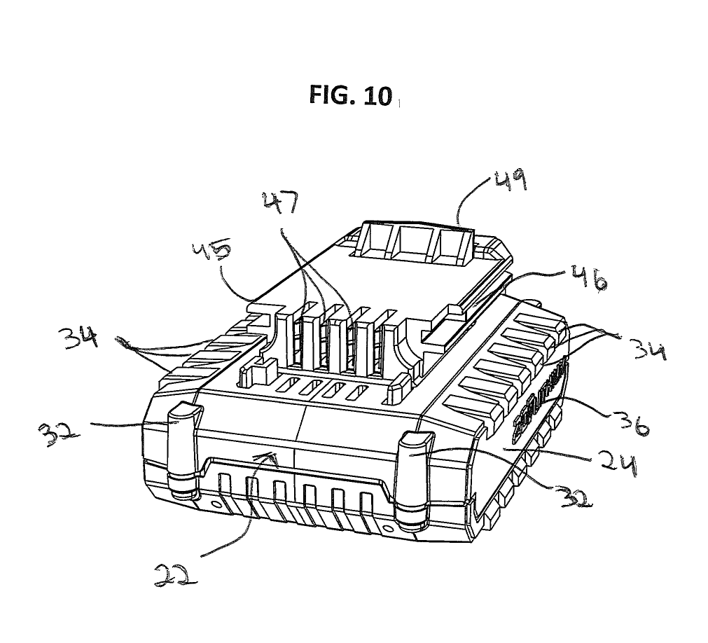

FIGS. 1-12 depict an example embodiment of a protective boot 10 for a battery pack 12 which can be fit onto a power tool such as a drill 100. The protective boot 10 is shown by itself in FIGS. 3-7 and in combination with the battery pack 12 in FIGS. 1, 11 and 12. The protective boot 10 is comprised of synthetic rubber although other types of elastic materials are contemplated by this disclosure. The protective boot 10 includes an opening sized to receive the battery pack 12. The cavity in the protective boot 10 is configured to fit a particular type of battery pack 12. It is readily understood that the concepts embodied in the protective boot 10 may be adapted for battery pack of varying shapes. The protective boot 10 is removable and replaceable.

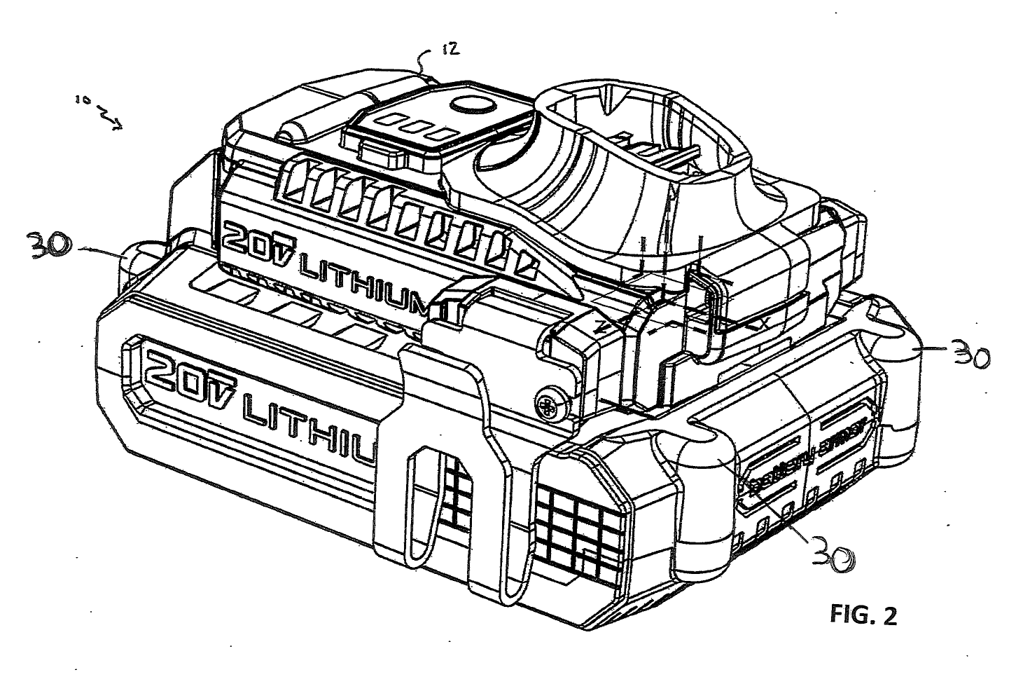

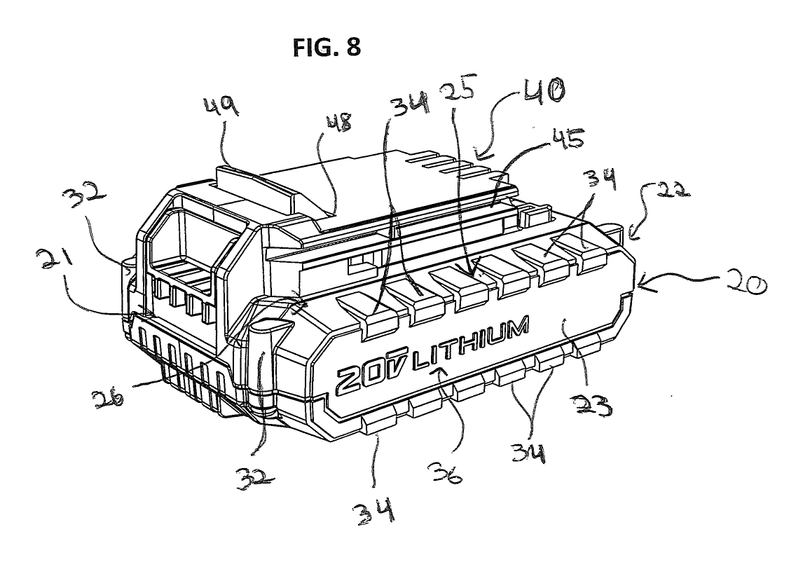

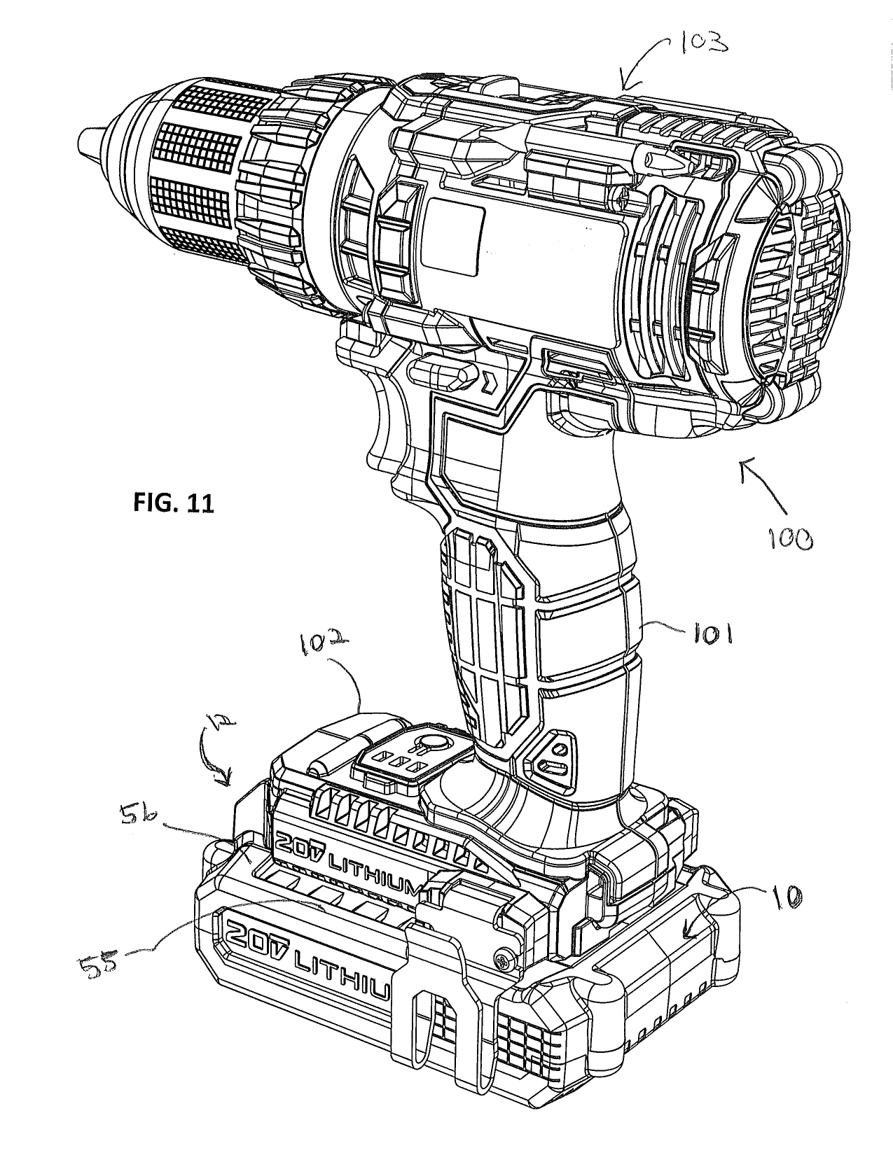

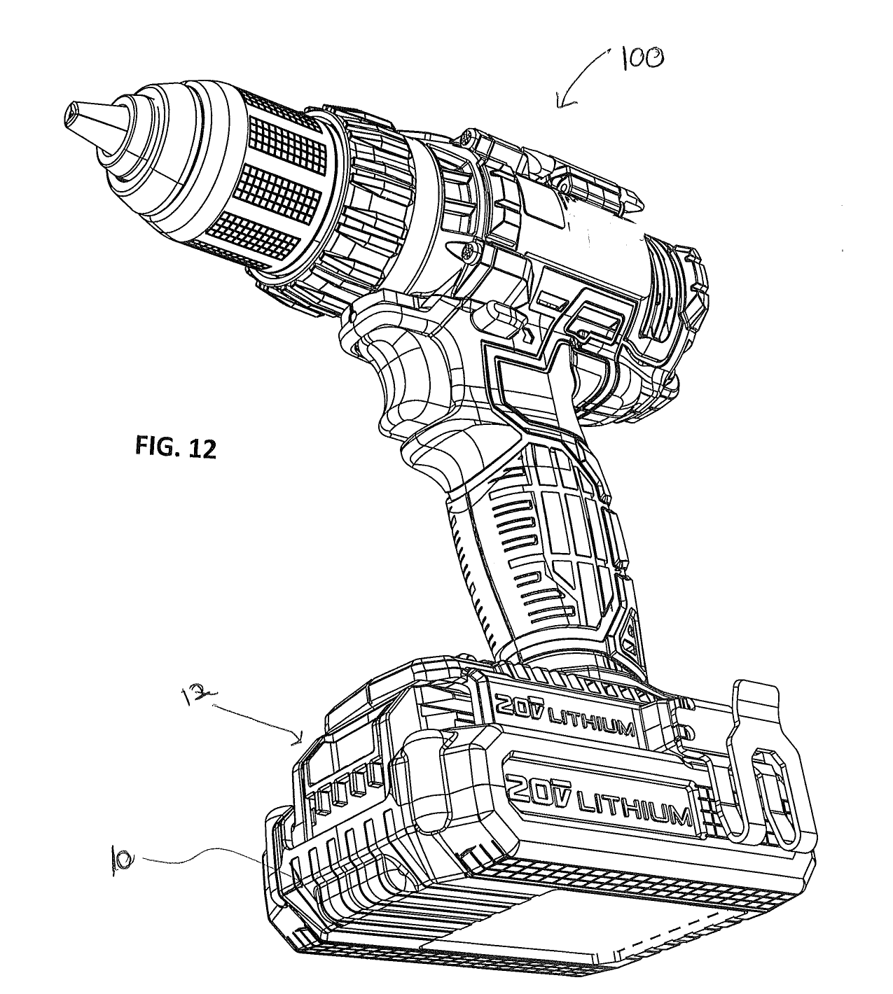

An exemplary embodiment of the battery pack 12 is shown in FIGS. 8-10. FIGS. 11 and 12 show the battery pack 12 with the protective boot 10 coupled thereto and attached to a power tool, in this case a drill 100. FIGS. 1 and 2 show the battery pack 12 with the boot 10 coupled to a power tool, but with the power tool cut away. The battery pack 12 may be operatively connectable to one or more power tools, appliances and/or other electric devices in order to provide electrical power to such devices. Additionally, the battery pack 12 may be connectable to a battery charger to recharge a battery. These connections may be formed by slidably engaging the battery pack 12 to the tool, battery charger or other electrical device.

As shown in FIGS. 8-10, the battery pack 12 includes a base portion 20 and an upper portion 40. The base portion 20 includes first and second ends 21, 22 and first and second sides 23, 24. The base portion 20 further includes a bottom 30 a first upper surface 25 adjacent to the first side 23 a second upper surface 26 adjacent to the second side 25. The base portion 20 also includes a third upper surface adjacent to the first end 21 at the first side 23 and a fourth upper surfaces 27 adjacent to the first end 21 at the second side 24. The battery 12 further includes several screw boss projections 32 and side projections 34.

The upper portion 40 may extend from the base portion 20 and may include first and second upper ends 41, 42. The first upper end 41 may include a plurality of terminal slots 47. The upper portion may also include first and second guide rails 45, 46. These guide rails may slidably engage corresponding guide rails on the power tool or charger to connect the battery pack and the power tool or charger.

The upper second end may be generally aligned with a second end of the base portion and may include an opening 48 through which a latch 49 extends. The latch 49 may be a part of a release mechanism for releasing the battery pack from engagement with the power tool or battery charger.

FIGS. 3-7 are drawings of an exemplary embodiment of the protective boot 10 when it is not attached to the battery pack 12. As shown in these figures, the protective boot 10 generally has first and second ends 51, 52, first and second sides 53, 54 a bottom side 60 and first, second, third and fourth upper sides 55, 56, 57, 58; which form fit around the respective first and second ends 21, 22, first and second sides 23, 24, bottom side 30 and first, second, third and fourth upper sides 25, 26, 27, 28 of the battery pack 12.

When the battery pack 12 is inserted into the protective boot 10, the protective boot 10 is form fitted around the battery pack 12. The protective boot 10 fully wraps around the side surfaces of the battery pack 12 as shown in the figures. The protective boot 10 also encases at least a portion of the bottom 30 of the battery pack 12. In this way, the protective boot 10 functions to protect a battery pack 12 inserted therein. The protective boot 10 optionally include windows on the side surfaces or the bottom surface which expose portions of the battery pack, including graphics, logos or warning labels residing thereon.

The elasticity of the protective boot 10 allows it to be stretched and flexed to some degree such that it can be form fit onto the battery pack 12, removed from the battery pack 12 and replaced with another protective boot 10. The boot 10 flexes back to a snug form fit once flexed and/or stretched to be fit on the battery pack 12. Because the protective boot 10 is form fit to the battery pack 12 it stays on the battery pack 12 without the use of fasteners or the like. This is accomplished in part by the number of opposing surfaces of the protective boot 10. For example, as shown in the figures, the protective boot 10 has a generally rectangular box shape that corresponds to the shape of the battery pack 12. Accordingly, it has a number of points of contact with the battery pack 12. For example, as discussed above, the protective boot 10 has a bottom 60 a first side 53 and an upper first surface 55. These cooperate so that the protective boot 10 wraps around the battery pack 12 at the first side 23 on a top, bottom and side surface, therefore preventing the protective boot 10 from becoming inadvertently removed from the battery pack 12. Of course, these three portions of the protective boot 10 further cooperate with the other portions to provide a full form fit.

The protective boot further includes a number of intermeshing features to further secure the boot 10 to the battery 12. These intermeshing features include a pair of first end cavities 62 and a pair of second end cavities 63. These first and second end cavities 62, 63 accept screw boss projections 32 from the battery 12. The cavities in the exemplary embodiment are concave have a partial cylindrical shape to accept screw boss projections 32, but other shapes for the projections and the cavities are contemplated. Additionally, the protective boot 10 includes a number of recesses 64 designed to mesh with the side projections 34 of the battery pack 12.

In the embodiment shown in figures, the protective boot 10 includes recesses and the battery 12 includes projections, but this could be reversed such that the protective cover included projections and the battery included recesses. As shown in the exemplary embodiment, there may be more than one different type of intermeshing features. For example, the exemplary embodiment of the battery pack 12 includes screw boss projections 32 and side projections 34 and the protective boot 10 includes corresponding features of matching shapes. Having different intermeshing features allows for the protective boot 10 to fit a battery pack 12 with a variety of ornamental or functional features and provides a particularly good fit between the protective boot 10 and the battery pack 12.

The protective boot 10 may further be aided in conforming to the battery pack 12 by the use of angled surfaces. As shown in, for example, FIG. 3, the protective boot 10 has a number of angled surfaces 59 which are angled with respect to the bottom 60. The angled surfaces 59 may be disposed at an angle to the bottom 60 of between 10 and 80 degrees. It may be advantageous to provide angled surfaces 59 at an angle of between 30 and 60 degrees. These angled surfaces allow for the protective boot 10 to more closely conform to the shape of the battery pack 12. They also aid in allowing the boot 10 to be removable while at the same time preventing inadvertent removal.

The protective boot 10 further includes a pair of side windows 71 and a bottom window 72. These windows allow a user to see battery pack graphics 36, such as logos and warning labels or the like. As shown in the figures, the windows 71, 72 are provided at flat surfaces. This allows for a large viewing area for the graphic information while at the same time providing good protection for the battery pack by covering the corners and the like. For example, as shown in FIG. 1, the side window 71 provides a large area of display. At the same time the corner between the first side 23 and the first end 21 is well protected such that any impact will be protected by the boot. In the exemplary embodiment, the windows 71, 72 are holes or cut-outs, but transparent materials may also be used for one or more of the windows.

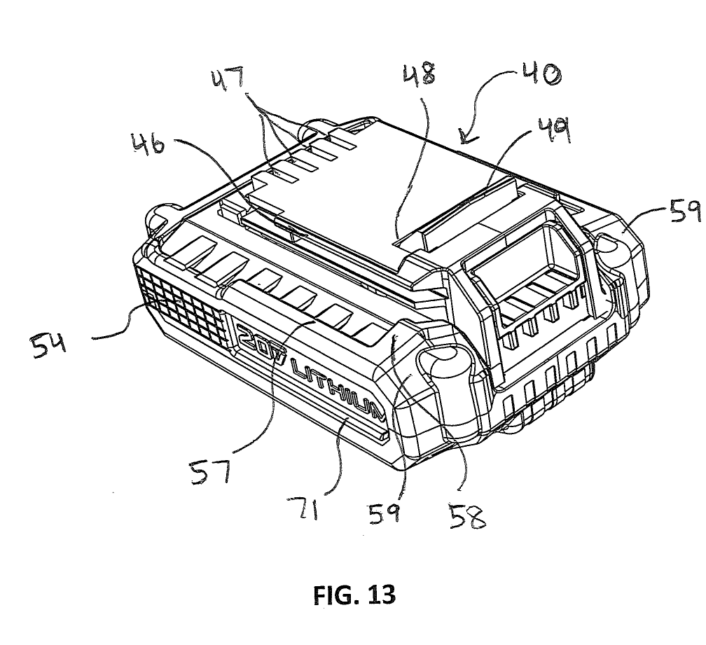

As shown in FIGS. 11 and 12, the drill includes a handle 101 and a main body which houses a motor and transmission as is known in the art. Additionally, the drill includes a foot 102 which receives the upper portion 40 of the battery pack 12. As shown in FIG. 13, the protective boot 10 is designed to cover a base 20 of the battery pack 12 while leaving the upper portion 40 exposed. The upper portion contains the guide rails 45, 46 and the terminal slots 47 for coupling with the drill 100. Leaving these portions exposed allow the battery pack 12 to be coupled without interference from the protective boot 10 while at the same time providing protection for the battery pack 12. Accordingly, as shown in FIGS. 11 and 12, the battery pack 10 can be protected by the protective boot 10 while engaged with a power tool.

The protective boot may be used with different battery packs for use with power tools, outdoor tools and the like, including those shown and/or described in WO 2014/062439, U.S. D680,064, U.S. D687,380 and U.S. D692,380, each of which are incorporated herein by reference in their entirety. In each instance, the protective boot could be modified such that it would form fit to the particular shapes of the battery pack.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A battery pack and a protective cover for the battery pack, comprising:
a battery pack which is operatively connectable to a power tool in order to provide electrical power to the power tool, the battery pack comprising a base portion and an upper portion, the base portion having a generally rectangular box shape and the upper portion extending from the base portion, the upper portion including at least one terminal slot and a plurality of guide rails; and
a protective boot which is removably coupled to the battery pack and comprises an elastic material and forming a substantially rectangular box shape conforming to the base portion of the battery pack such that when it is coupled to the battery pack it is form fitting and covers at least a portion of an outer surface of the base portion; and
wherein the at least one terminal slot and the plurality of guide rails of the battery pack are exposed when the protective boot is coupled to the battery pack.

2. The battery pack and protective cover of claim 1, wherein the base portion of the battery pack further comprises at least one of projections and recesses and the protective boot comprises at least one of cavities for receiving the projections and projections for engaging the recesses.

3. The battery pack and protective cover of claim 2, wherein the battery pack includes a plurality of projections extending from the base portion and the protective boot comprises a plurality of cavities which receive the plurality of recesses.

4. The battery pack and protective cover of claim 3, wherein the plurality of projections include at least a first projection of a first shape and a second projection of a second shape and the plurality of cavities comprise at least a first cavity with a first cavity shape and a second cavity with a second cavity shape.

5. The battery pack and protective cover of claim 1, wherein the base portion comprises graphical information and the protective boot comprises at least one window through which the graphical information is visible.

6. The battery pack and protective cover of claim 5, wherein the at least one window comprises a hole in the protective boot.

7. The battery pack and protective cover of claim 6, wherein the graphical information comprises alphanumeric characters.

8. The battery pack and protective cover of claim 2, wherein the projections comprise screw boss projections.

9. The battery pack and protective cover of claim 2, wherein the projections comprise a portion which is at least substantially cylindrical.

10. The battery pack and protective cover of claim 9, wherein the cavities comprises a portion which is at least substantially cylindrical to receive the at least substantially cylindrical projections.

11. The battery pack and protective cover of claim 1, wherein the upper portion of the battery pack is exposed when the protective boot is coupled to the battery pack.

12. A power tool assembly comprising:
a battery pack;
a protective boot for the battery pack; and
a power tool;
the battery pack being operatively connectable to the power tool in order to provide electrical power to the power tool, the battery pack comprising a base portion and an upper portion, the base portion having a generally rectangular box shape and the upper portion extending from the base portion and the upper portion including at least one terminal slot and a plurality of guide rails; and
the protective boot being removably coupled to the battery pack and comprising an elastic material and forming a substantially rectangular box shape conforming to the base portion of the battery pack and covering at least a portion of an outer surface of the base portion;
wherein the base portion of the battery pack further comprises at least one of projections and recesses and the protective boot comprises at least one of cavities for receiving the projections and projections for engaging the recesses.

13. The power tool assembly of claim 10, wherein the projections include at least a first projection of a first shape and a second projection of a second shape and the plurality of cavities comprise at least a first cavity with a first cavity shape and a second cavity with a second cavity shape.

14. The power tool assembly of claim 10, wherein the base portion comprises graphical information and the protective boot comprises at least one window through which the graphical information is visible.

15. The battery pack and protective cover of claim 4, wherein the at least one window comprises a hole in the protective boot.

16. The battery pack and protective cover of claim 5, wherein the graphical information comprises alphanumeric characters.

17. The battery pack and protective cover of claim 1, wherein the projections comprise a portion which is at least substantially cylindrical.

18. The battery pack and protective cover of claim 8, wherein the cavities comprises a portion which is at least substantially cylindrical to receive the at least substantially cylindrical projections.

19. A protective cover for a battery pack, comprising:
a boot comprising an elastic material and forming a substantially rectangular box shape opening in which at least a portion of the battery pack can be received;
the boot further comprising a plurality of recesses for receiving a plurality of projections from the battery pack;
the plurality of recesses comprising a first recess having a first shape and a second recess having a second shape different than the first shape.

20. The protective boot of claim 19, further comprising at least one window, the window being located on a side surface.
